(19) United States
(12) Patent Application Publication
(10) Pub. No.: US 2019/0213283 A1
(43) Pub. Date: Jul. 11, 2019

(54) SYSTEMS AND METHODS FOR PERSONALIZED BROWSING

(71) Applicant: Capital One Services, LLC, Mclean, VA (US)

(72) Inventors: Abdelkader Benkreira, Washington, DC (US); Michael Bakr Mossoba, Arlington, VA (US); Joshua Edwards, Philadelphia, PA (US)

(21) Appl. No.: 15/864,530

(22) Filed: Jan. 8, 2018

(51) Int. Cl. G06F 17/30; H04L 29/08; G06F 21/62

(52) U.S. Cl. CPC G06F 17/30899; H04L 67/306; H04L 67/22; H04L 67/025; G06F 21/6263

(57) ABSTRACT

Embodiments of the present disclosed technology relate to methods for providing a personalized browsing experience. In some embodiments, a browser or browser add-on can append personalization data to an outgoing web request to allow a web server to respond with content personalized to the user according to the personalization data. In some embodiments, a user can set the values of personalization data sent to web servers. In some embodiments, a user can determine which websites receive the personalization data.

### FIELD OF INVENTION

The present disclosed technology relates to systems and methods for providing a personalized browsing experience.

### BACKGROUND

Website providers often desire to personalize the appearance of their webpages to individual users. For example, online retailers may desire to display recommended items to a user on their homepage, and potentially to customize those products to a particular user. As another example, news websites may want to deliver a webpage customized to a user's interest. Conventional systems and methods for providing this type of personalization typically require the user to login to an account that contains personalization information, or to obtain personalization information and assign it to site-specific cookies. Rather than either directly collecting this information, websites can resort to other potentially intrusive methods. For example, a website may require a user to connect the website to one of their social media accounts to provide personal data. Users may not want to provide this connection because of the risk that irrelevant, and potentially confidential private information may be inadvertently shared with that website. Alternatively, websites could turn to tracking cookies, which are services that track a user from website to website by embedding a tracking cookie in the user's browser.

Thus, conventional approaches to personalized browsing thus suffer from numerous limitations felt by both the website provider and the user. For example, website providers must go to great lengths to collect this information from users, and once collected, websites frequently cannot or do not wish to share that information with other websites, leading to duplicated effort. Users can become frustrated with websites that require registration and a log-in prior to providing useful information. Further, many users are concerned that indirect information collection methods may invade their privacy or compromise their identity. Users can further prevent indirect information collection methods from functioning by refusing to connect their social media accounts, setting their browsers to include “Do Not Track” requests to websites, and directly blocking tracking cookies or connections to domains known to be used for tracking.

What is needed is a technique to allow for websites to provide a personalized browsing experience to each user without some or all of these limitations. Embodiments of the present disclosure include systems and methods to allow websites to provide personalized browsing experiences while providing users control over the personal information provided to websites.

### SUMMARY OF THE INVENTION

Some embodiments of the present disclosed technology relate to a method for providing a personalized browsing experience, comprising receiving at a browser one or more items of personalization data from a user, receiving a request from a user for a web site from a web server, and appending the one or more items of personalization data to the request for a web site.

In some embodiments, the step of appending the one or more items of personalization data to the request includes appending a cookie to the request containing the one or more items of personalization data. In some embodiments, appending a cookie to the request is performed prior to receiving a response from the web server indicating that a cookie with the same key as the appended cookie should be set by the browser. In some embodiments, the one or more items of personalization data is selected as a subset of a list of stored personalization data for the user. In some embodiments, the one or more items of personalization data are selected from a profile selected from one or more profiles associated with the user. In some embodiments, one or more of the steps of receiving one or more items of personalization data, receiving a request from a user for a web site, and appending the one or more items of personalization data to the request is performed by a browser add-on. In some embodiments, the subset of a list of stored personalization data is selected from a database of types of personalization data accepted by the web site requested by the user. In some embodiments, the subset of a list of stored personalization data is selected based on a user preference applicable to the web site requested by the user.

Some embodiments of the present disclosed technology relate to a method for providing a personalized browsing experience, comprising receiving an outgoing request to a web server for a website at a browser, determining whether at least one kind of personalization data corresponding to a user of the browser can be sent to the web site, and appending the at least one kind of personalization data corresponding to a user of the browser to the outgoing request based on a positive determination that the personalization data can be sent to the web site, or refraining from appending the at least one kind of personalization data corresponding to a user of the browser to the outgoing request based on a negative determination that the personalization data can be sent to the web site.

In some embodiments, the determining whether at least one kind of personalization data corresponding to a user of the browser can be sent to the web site is based at least partially on a whitelist of allowed web sites. In some embodiments, the determining whether at least one kind of personalization data corresponding to a user of the browser can be sent to the web site is based at least partially on a blacklist of disallowed web sites. In some embodiments, the determining whether at least one kind of personalization data corresponding to a user of the browser can be sent to the web site is based at least partially on a user setting indicating that the web site is an allowed web site or a disallowed website. In some embodiments, the determining whether at least one kind of personalization data corresponding to a user of the browser can be sent to the web site is based on a list of allowed or responsive personalized data associated with the web site. In some embodiments, the at least one kind of personalization data is set by the user. In some embodiments, the at least one kind of personalization data is obtained from a profile of a plurality of profiles associated with a user.

Some embodiments of the present disclosed technology relate to a method for providing a personalized browsing experience, comprising: receiving a request for a resource from a computing device associated with a user at a web server, transmitting a response to the user containing the requested resource, wherein the response further comprises data indicating at least one kind of personalization data accepted by the web server for providing personalized responses to requests for resources.

In some embodiments, the data further comprises a validation criterion for the kind of personalization data accepted by the web server. In some embodiments, the data indicating at least one kind of personalization data accepted by the web server further comprises data indicating one of an acceptable list of values or an acceptable range of values for the at least one kind of personalization data accepted by the web server. In some embodiments, the data indicating at least one kind of personalization data accepted by the web server further comprises data indicating one of an acceptable range of values for the at least one kind of personalization data accepted by the web server. In some embodiments, the method further comprises receiving a request for a resource from a computing device associated with the user at a web server containing an item of personalization data associated with the user, and returning a response to the computing device associated with the user containing a personalized website based at least in part on the item of personalization data associated with the user.

### BRIEF DESCRIPTION OF THE FIGURES

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 depicts a system in accordance with an embodiment;

FIG. 2 depicts an example computing device in accordance with an embodiment;

FIG. 3 depicts an HTTP request and a corresponding HTTP response;

FIG. 4 depicts a series of HTTP requests and responses wherein the server sets cookies, and the client responds by re-sending the cookies to the server;

FIG. 5 depicts a user interface for setting personalization data at a browser in accordance with an embodiment;

FIG. 6 depicts a website responsive to an item of personalization data displaying a dialog box prompting the user to enter personalization information;

FIG. 7 depicts a user interface that displays websites that can receive personalization data, along with the fields accepted by the websites, and a field for a user to customize what data is delivered to websites in accordance with an embodiment;

FIG. 8 depicts a method in accordance with an embodiment for appending items of personalization data to requests for websites;

FIG. 9 depicts a method in accordance with an embodiment for determining whether an item of personalization data should be appended to a request for a web site, and either appending or not appending the item of personalization data in response to the determination;

FIG. 10 depicts a method in accordance with an embodiment for responding to a request for a web site containing an item of personalization data;

FIG. 11 depicts a request for a website including cookies indicating items of personalization data, and a personalized web site returned by the web server in accordance with an embodiment;

FIG. 12 depicts a request for a website responsive to un-set items of personalization data, and a server response indicating the information that the website is responsive to, and further a request including that item of personalization data and a returned personalized web page, in accordance with an embodiment; and

FIG. 13 depicts a request for a website in accordance with an embodiment including several items of personalization data, including a reason for browsing, and further depicts the responsive personalized website returned by a web server in accordance with an embodiment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same reference numbers will be used throughout the drawings to refer to the same or like parts.

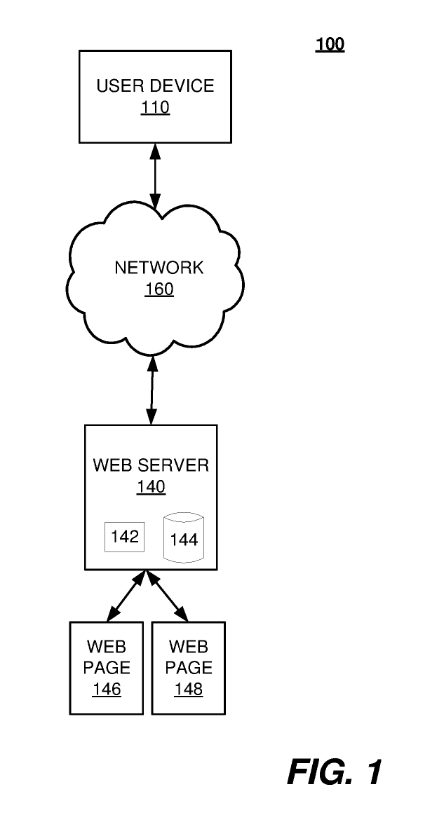

FIG. 1 is a diagram of an exemplary system that may be configured to perform one or more processes in accordance with an embodiment. The components and arrangements shown in FIG. 1 are not intended to limit the disclosed embodiments as the components used to implement the disclosed processes and features may vary.

In accordance with disclosed embodiments, a browsing system 100 may include a user device 110. A browsing system can further include one or more web servers 140 with processing units 142 and data storage 144 for providing one or more webpages 146, 148. User device 110 may be a mobile computing device (e.g., a smart phone, tablet computer, smart wearable device, portable laptop computer, voice command device, wearable augmented reality device, or other mobile computing device).

Web server 140 may be associated with an entity such as a business, corporation, individual, partnership, or any other entity that may be a seller of good and/or services such as a grocery store, a movie theater, a media outlet, a gas station, or the like. According to some embodiments, the organization may be associated with an entity such as a business, corporation, individual, partnership, or any other entity that may provide financial services or processing of financial transactions such as a bank, a credit card company or the like. According to some embodiments, the organization may be associated with an entity that provides goods and services.

Network 160 may be of any suitable type, including individual connections via the internet such as cellular or WiFi networks. In some embodiments, network 160 may connect terminals using direct connections such as radio-frequency identification (RFID), near-field communication (NFC), Bluetooth™, low-energy Bluetooth™ (BLE), WiFi™, ZigBee™, ambient backscatter communications (ABC) protocols, USB, Ethernet, or LAN. In some embodiments, data can be transmitted across the network in either an encrypted or un-encrypted format.

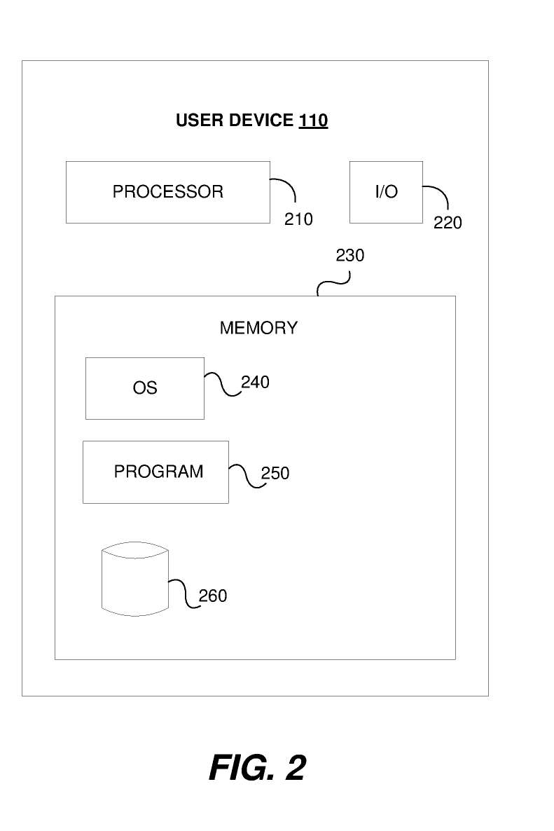

An exemplary embodiment of user device 110 is shown in more detail in FIG. 2. As shown, user device 110 may include a processor 210, an input/output (“I/O”) device 220, a memory 230 containing an operating system (“OS”) 240 and a program 250. For example, user device 110 may be a single server or may be configured as a distributed computer system including multiple servers or computers that interoperate to perform one or more of the processes and functionalities associated with the disclosed embodiments. In some embodiments, user device 110 may further include a peripheral interface, a transceiver, a mobile network interface in communication with processor 210, a bus configured to facilitate communication between the various components of user device 120, and a power source configured to power one or more components of user device 120.

Processor 210 may be one or more known processing devices, such as a microprocessor from the Pentium’ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft® SQL databases, SharePoint® databases, Oracle® databases, Sybase™ databases, Postgres, MariaDB®, Couchbase™, Redis™, MongoDB® or other relational or non-relational databases. Memory 230 may include software components that, when executed by processor 210, perform one or more processes consistent with the disclosed embodiments.

Network 160 can comprise a mobile network interface that provides access to a cellular network, the Internet, or another wide-area network. In some embodiments, a mobile network interface may include hardware, firmware, and/or software that allows processor(s) 210 to communicate with other devices via wired or wireless networks, whether local or wide area, private or public, as known in the art. A power source may be configured to provide an appropriate alternating current (AC) or direct current (DC) to power components.

As described above, user device 120 may be configured to remotely communicate with one or more other devices, such as web server 140. Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

In some embodiments of the disclosed technology, a method is provided for transmitting personalization data to websites. In some embodiments, personalization data can be transmitted using cookies. Cookies are fragments of information that a web server can set on particular browsers, and that are transmitted to the server with each request.

In some embodiments, cookies can be cookies as defined by the Internet Engineering Task Force RFC 6265—HTTP State Management Mechanism. Cookies are a mechanism that allow web servers to determine some information about who is requesting certain data. Requests for webpages on the internet are typically sent as HTTP requests, which are ordinarily “stateless.” That is, each request is processed by a web server without any additional context. Cookies allow a server to correlate requests to a specific user to provide more personalized content.

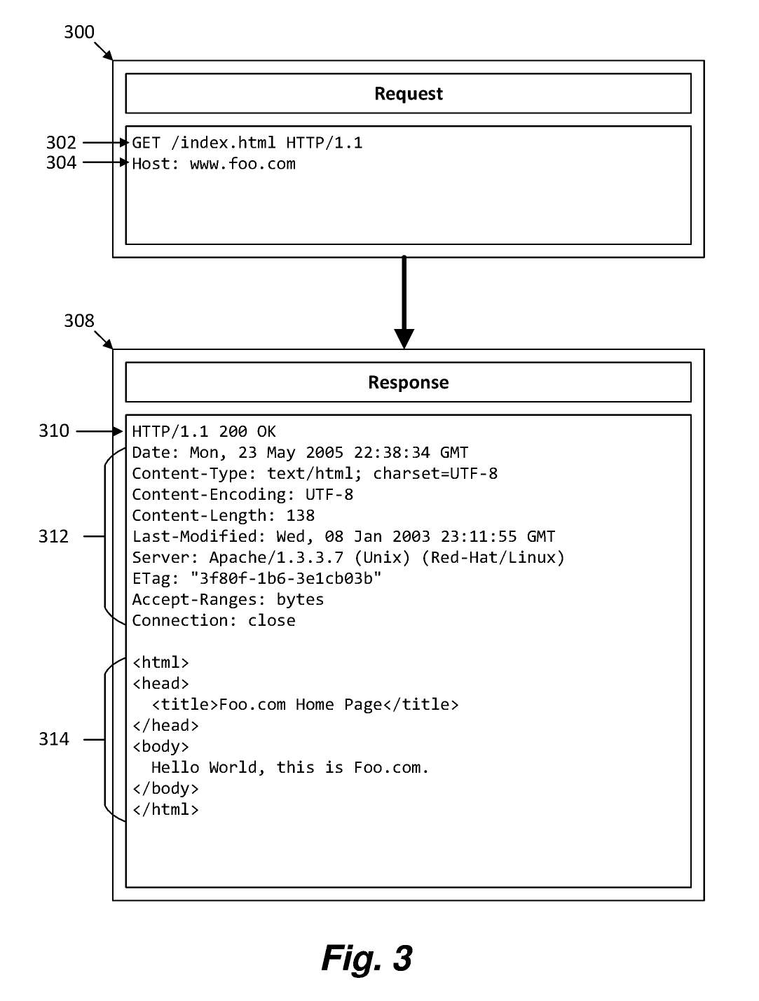

FIG. 3 depicts an example HTTP request and response without cookies for www.foo.com/index.html. Such a request can be sent in response to a user indicating to a browser that they wish to visit www.foo.com. Each HTTP request 300 can contain a requested resource 302 that can include a path and a verb (e.g. GET, POST, HEAD, etc.), one or more header fields 304, and an optional message body (not shown). A web server then processes the HTTP request and returns a response 308. The response contains a status field 310, that contains a code such as an informational code 1xx, successful code 2xx, a redirection code 3xx, a client error code 4xx, or a server error code 5xx. The response 308 can further contain one or more header fields 312 that contain data such as the date and time of the request, the format and size of the response, caching data, and other information. Further, the response 308 can contain a response body 314. In this example, the response body is the HTML code for the requested webpage. A complete specification for version 1.1 of the HTTP protocol is provided in the Internet Engineering Task Force RFC 2616—Hypertext Transfer Protocol—HTTP/1.1.

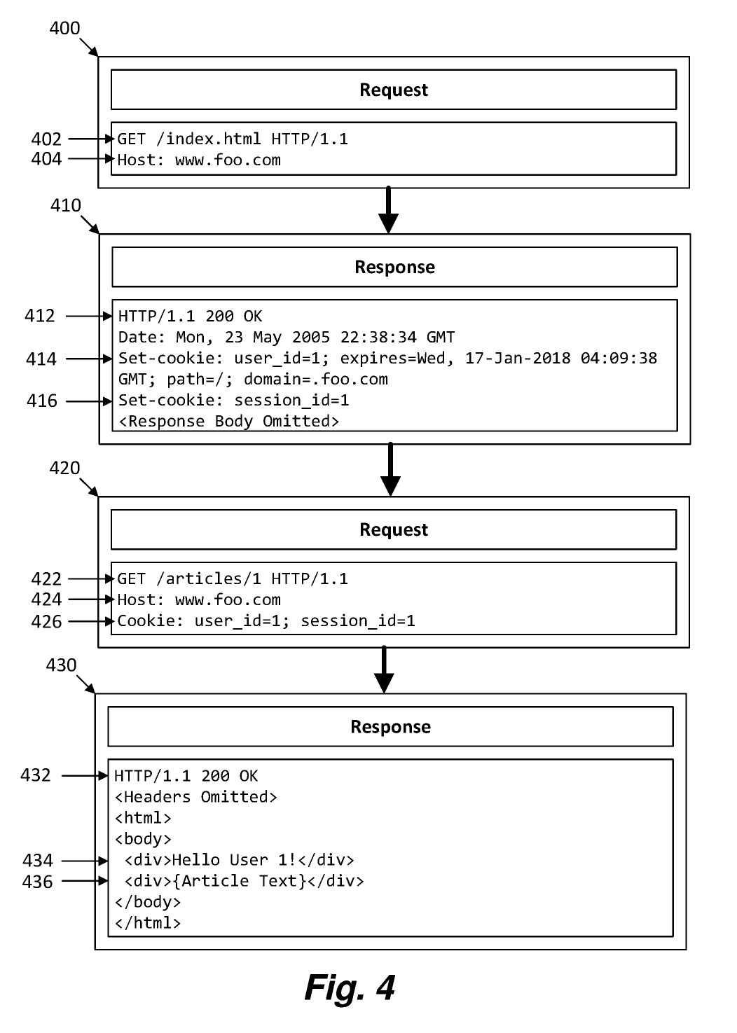

FIG. 4 depicts an example of a series of requests and responses from a server that sets and reads a cookie to correlate both requests with the same user. Request 400 is identical to the request in FIG. 3, including the same requested resource 402 and header fields 404. However, the server returns a response with “Set-cookie” header fields 414 and 416. Cookies comprise at least a key-value pair, and can optionally contain a domain, path, and expiration date. The cookie set in header 414 is a cookie that indicates the user making the request, using the key value “user_id”, and assigns the value of the cookie to 1. The cookie field 414 further indicates that the cookie expires at a certain date, is valid for the path “/” (which includes all paths), and for the domain “.foo.com”. For example, if a cookie indicates that the host is “foo.com,” and the path is “/users,” the cookie will not be sent with requests that do not contain the path or host, such as requests to bar.com, or with requests to foo.com/index.html. In contrast, a request to foo.com/users/list.html will contain the cookie because the path of the URL is within the path of the cookie. Cookies sent without host and path fields default to the host and path of the request that resulted in the cookie being set. For example, in Response 410, the server sets a session cookie 416 without a specific domain, path, or expiry. This session cookie 416 will only be valid for the domain “.foo.com,” and for the path “/” by default, and will be forgotten when the browser is closed.

If the same user sends a subsequent request 420, the browser will send the same resource request 422 and headers 424, but will automatically append an additional header field containing the key-value pairs for the cookies 426 corresponding to that domain. In this example, request 420 is for article number 1. Because the request is for www.foo.com, and the path to the article is a sub-path of “/”, both cookies are sent to the server. The server can then send a response 430 that is valid 432 that contains the requested content 436, and a personalized message to the user 434. While the example response 430 depicts a response body that comprises HTML, as would be understood by a person of ordinary skill in the art, the response can be of any appropriate type. For example, the response can comprise plain text, Javascript Object Notation (JSON) data, Extensible Markup Language (XML) data, binary content, or any other content type.

Because cookies can expose user data to websites, modern browsers can place several constraints on how cookies can be set and interpreted. For example, many browsers implement a “Same Origin” policy, meaning that cookies cannot be set by a server for paths or domains outside the current request. That is, a response from foo.com cannot set a cookie for bar.com, nor can a request to foo.com/users set a cookie to foo.com/posts. Further, modern web development conventions avoid placing personally identifiable information in cookies. Instead, websites can set a cookie with a cryptographically secure random value to identify a user, and then store that random value in a database that connects it to a user. For example, when user1234 is successfully authenticated for a website, the website can send a “Set-Cookie” field for “user_auth=5653787690,” and store in a local database that authentication number 5653787690 corresponds to user1234. When it receives a request with the authentication number, it correlates the number to a user, and then delivers a personalized webpage based on data known to the server about that user.

Embodiments of the present disclosed technology enable users to provide personalization data to websites though cookies by altering the normal functionality of cookies. While a typical cookie requires that a web server first expressly set the value, embodiments of the present technology allow a user to indicate items of personalization data to be sent as cookies without being set by the server. Examples of such personalization data may include clothing sizes, gender, media preferences, or any other item of data that would allow a website to customize its appearance to a user. Embodiments of the present invention additionally can comprise user interfaces and security policies to provide users the ability to control what information is provided to what website.

In some embodiments, these cookies can be set by intercepting outgoing HTTP requests, and appending cookies to the request that contain personalization data. In some embodiments, cookies can be appended by the browser itself. In some embodiments, cookies can be appended to outgoing requests by an add-on or extension to the browser.

In one embodiment, a user can indicate to a browser that they would like websites to know that they are male and wear size 12 shoes. Such an indication can be made at a user interface provided by the browser, such as a settings page, for example. When a user visits a webpage for a shoe retailer, the browser will then send a cookie to the webpage indicating the user's shoe size, such as “shoeSize=12M.” The website can then respond to the cookie by showing shoes in stock in a size 12, or only showing shoes for men, for example.

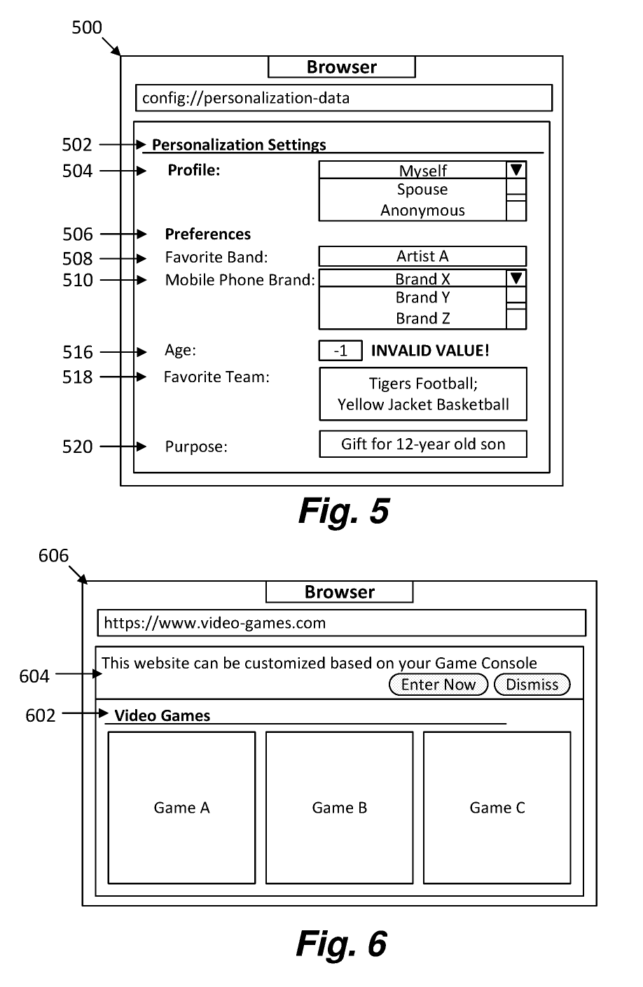

FIG. 5 depicts a user interface for providing personalization data to a browser in accordance with an embodiment. Here, a user interface 502 in a browser 500 is provided to allow a user to provide personalization data. In some embodiments, a user can select from a plurality of profiles 504, such as to allow separate personalization data to be stored for different people (such as a Spouse, who may access the computer as the same user), or for different purposes (such as an Anonymous profile), among other reasons. A user interface 502 in accordance with an embodiment can display one or more preferences 506, or items of personalization data that can be set. For example, this user interface allows a user to select his favorite band 508, mobile phone brand 510, and/or age 516. In some embodiments, certain preference values can be text fields that can be entered as any value, such as the name of a person's favorite band 508. In some embodiments, certain preference values can be selected from a list of accepted values, such as mobile phone brand 510, where a user can select between Brand X, Brand Y, and Brand Z. In some embodiments, certain preferences can have other validation criteria, such as acceptable range of numeric values, or allowed characters or sequences of characters. In the example in FIG. 5, the preference for age 516 can refuse to accept negative ages. In some embodiments, a preference can be set multiple times or have multiple values, such as preference for favorite sports teams 518. In some embodiments, short-lived or session preferences can also be set, such as a brief explanation of why the user is browsing the internet 520.

FIG. 6 depicts a user interface for providing personalization data to a browser 606 in accordance with an embodiment. In some embodiments, websites 604 can indicate to a browser that certain items of personalization data are recognized by the website. For example, if a user visits a video game website, the website can indicate that it responds to personalization data based on the type of video game system used by the server—e.g. PlayStation, Xbox, or PC. Such an indication can be provided by, for example, sending a “Set-Cookie” header with a list of responsive fields. In some embodiments, the server can send a “Set-Cookie” header with key-value pairs having the accepted key with a missing or empty placeholder value, such as “userConsole=;” or “userConsole=undefined;” In some embodiments, the key-value pairs can have an accepted key along with a validation criterion, such as a data type, allowed range of values or characters, or a list of accepted values.

In some embodiments, a browser can respond to the indication that a website accepts a value by displaying a dialog box indicating that a particular item of personalization data is accepted by the website, such as the owner's game console. In some embodiments, the dialog box 604 can provide the option to enter the item of personalization data. In some embodiments, the advertisement can be text displayed within the webpage. In some embodiments, the advertisement can be provided by the browser when it detects that the website responds to a cookie. In some embodiments, a browser can prompt a user to set one or more items of personalization data in response to the webpage's advertisement.

In some embodiments, personalization data can be set in key-value pairs that correspond to a field convention. For example, the key for each cookie of personalization data may contain a prefix or suffix to indicate that it is personalization data. For example, the prefix “user” can be used in key values such as “userShoeSize,” “userMusicGenre.” Suffixes could be used according to an embodiment, such as “Preference,” (e.g. “shirtSizePreference”, “videoGamePreference”). In some embodiments, a global list of possible personalization data values can be provided, such as by the provider of the web browser or a third party.

In some embodiments, the value of personalization data can conform to a predetermined schema. For example, a shoe size could have the schema of <country><size><gender><width>. In this schema, the value of a shoe size could be US12M.D, indicating that the user has a male size 12 shoe size, with a width of D according to the US sizing system. In other embodiments, the value of personalization data can comprise JSON or XML data. For example, the same shoe size could be represented in JSON as:
userShoeSize={“country”: “US”, “size”: “12”, “gender”: “Male”, “width”: “D”}

Alternatively, the same information could be represented as XML in the form:

userShoeSize=

<shoeSize>

<country>US</country>
<size>12</size>
<gender>M</gender>
<width>D</width>

</shoeSize>

Embodiments of the present invention can encode personalization information in any machine-readable manner, according to any machine-readable schema, including encrypted or binary data. In some embodiments, the encoding of personalization information can include percent-encoding (e.g. URL encoding) cookie keys or values to encode otherwise disallowed characters. In some embodiments, percent-encoding can be performed as described in IETF RFC 3986—URI Generic Syntax, at § 2.1. For example, if the personalization information was “shopping for my 16-year-old son,” that value can be encoded as “shopping%20for%20my%2016-year-old%20son”.

In some embodiments, the browser can filter what websites receive the personalization data based on either a whitelist or a blacklist. For example, a browser may have a whitelist of trusted websites to which it provides personalization data according to an embodiment. When the browser visits such a website, it can provide the personalization data to the whitelisted website. In another embodiment, the browser may have a blacklist of untrusted websites that personalization data should not be sent to. When a user visits a blacklisted website, the browser will refrain from sending the cookie with the request.

As would be understood by a person of ordinary skill in the art, other combinations of whitelists and blacklists could be used. For example, according to an embodiment, a browser may only have a whitelist of allowed websites, and refuse to send personalization data to any site not on the whitelist. In another embodiment, a browser may only have a blacklist of prohibited websites, and send personalization data to any website not on the blacklist.

Alternatively, an embodiment may use both a blacklist of prohibited websites and a whitelist of allowed websites, and by default either refuse to send personalization data, or send personalization data to any website not on either the whitelist or blacklist. In an embodiment, a whitelist and/or blacklist can be included with the browser software, or downloaded from a predetermined server. In some embodiments, the whitelist and/or blacklist can be updated over the internet, such as periodically, or at a user's request. In yet another embodiment, a user can set or modify a whitelist or blacklist to select which websites should receive personalization data.

In some embodiments, the browser can filter what kind of personalization data is received by a website based on a list of allowed or responsive personalization data. For example, if a user visits a clothing retailer that does not sell shoes, the browser can send personalization data about the user's preferred shirt style or pant size, but not shoe size. In some embodiments, the list of allowed or responsive personalization data can be provided by a centralized server to the browser.

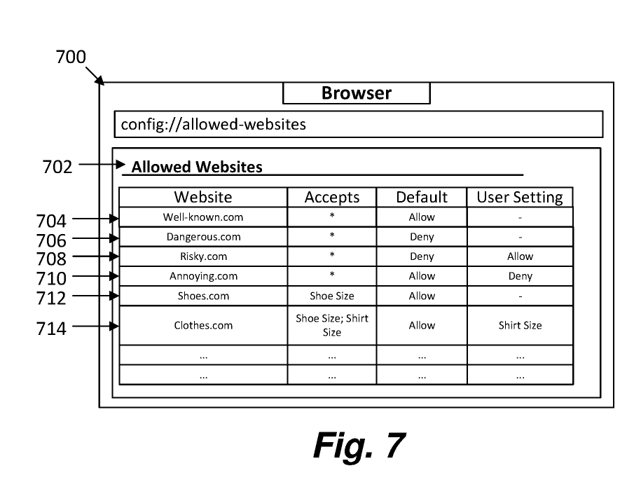

FIG. 7 provides an example of a browser 700 displaying a user interface 702 allowing a user to view blacklist and/or whitelist settings for various websites, and adjust values according to their preferences. For example, a well-known website 704 can be displayed as having a default value of “Allow,” indicating that personalization data is shared with the well-known website. Alternatively, a dangerous website 706 can be displayed as having a default value of “Deny,” indicating that personalization data will not be sent with the dangerous website. In some instances, a risky website 708 can have a default value of “Deny,” however a user may decide that they want to share personalization data with the risky website, and provide a user setting of “Allow” to the risky website. In some instances, a particularly annoying website 710 may have a default value of “Allow,” but a user may decide that they do not want to share personalization data with that annoying website 710. In some embodiments, a browser may send a sub-set of personalization data based on knowledge that the website only provides personalized content based on certain items of personalization data. For example, a shoe retailer 712 may only personalize the website based on shoe size, and therefore the browser will only send the shoe size personalization data. In some embodiments, a user can further provide a setting indicating that only a sub-set of personalization data should be shared with the website. For example, a clothing retailer 714 may provide personalization based on shoe size, but may not be the user's preferred shoe retailer. Therefore, a user can determine that only their shirt size, and not their shoe size, should be shared with the website.

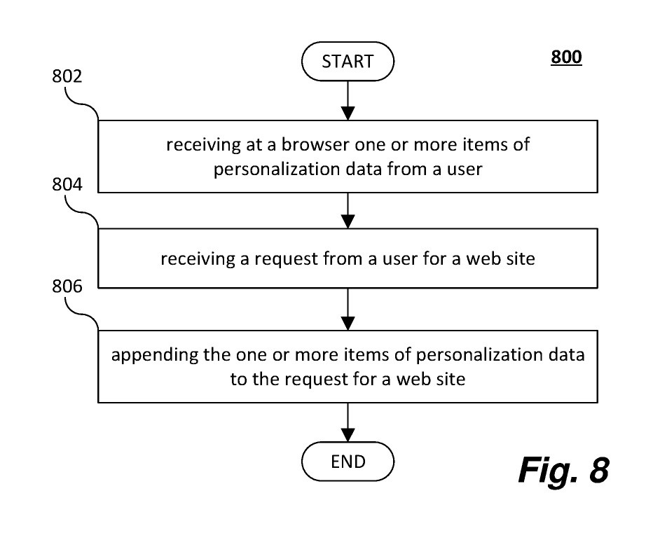

FIG. 8 illustrates a method 800 in accordance with an embodiment. The method is accomplished by receiving at a browser one or more items of personalization data from a user 802. The personalization data can be any item of data specific to a user or a preference of the user. The personalization data can be received by any method, such as retrieval from a database, either locally or in the cloud, or obtained through a user interface. The method further comprises receiving a request from a user for a web site 804. The request can be received by typing a URL in an address bar, or clicking a user interface element corresponding to the web site, such as a hyperlink. In some embodiments, the request for a web site may be a request for an updated view of a current website. In some embodiments, the request can be an AJAX or WebSockets request. In some embodiments, the step of receiving a request 804 can be performed before the receipt of personalization data. For example, in some embodiments, the receipt of a request for a web site may trigger a mechanism for obtaining personalization data, such as fetching it from a web server, or presenting a user interface to the user to receive the personalization data. The method further comprises appending the one or more items of personalization data to the request for a web site 806. In some embodiments, this can be performed by appending a cookie to the request prior to sending it to a web server associated with the requested web site. In some embodiments, this can be performed by including the personalization data in a different part of an HTTP request, such as including it in the URL, a query string, a header field, or in the HTTP request body.

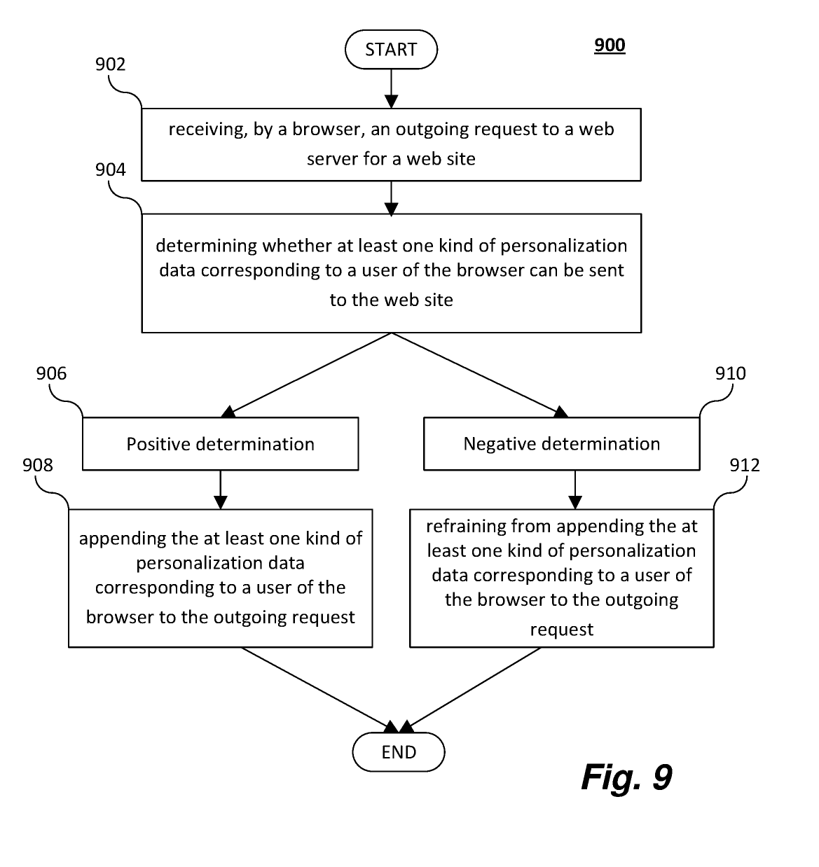

FIG. 9 illustrates a method 900 in accordance with an embodiment. The method is accomplished by receiving, by a browser, an outgoing request to a web server for a web site 902. This step can be performed by a browser itself, or a browser add-on that can access outgoing requests. The method further comprises determining whether at least one kind of personalization data corresponding to a user of the browser can be sent to the web site 904. In some embodiments, this determination can be made based on a whitelist of allowed websites or a blacklist of disallowed websites. In some embodiments, this determination can be made based on user preferences, or user modifications of a whitelist of allowed websites or a blacklist of disallowed websites. Where the method results in a positive determination 906, the method further can comprise appending the at least one kind of personalization data corresponding to a user of the browser to the outgoing request. In some embodiments, the kind of personalization data can be associated with one of a plurality of profiles corresponding to a user of the browser. In contrast, where the method results in a negative determination 910, the method further can comprise refraining from appending the at least one kind of personalization data corresponding to a user of the browser to the outgoing request.

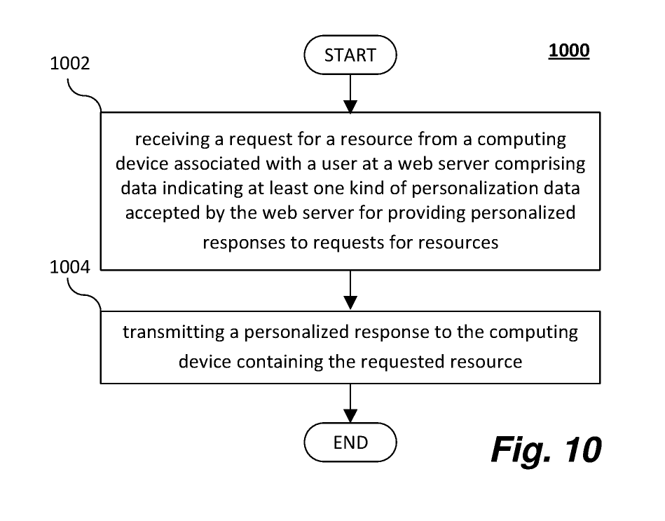

FIG. 10 illustrates a method 1000 in accordance with an embodiment. The method is accomplished by receiving a request from a computing device associated with a user at a web server comprising data accepted by the web server for providing personalized responses to requests for resources 1002. In response to the request, the method further comprises transmitting a personalized response to the computing device containing the requested resource 1004.

While some embodiments of the present disclosed technology are discussed in terms of cookies, other methods can be used within the scope of the present disclosure. In some embodiments, personalization data can be sent in custom header fields, such as a “Personalization-Data” field. In some embodiments, personalization data can be sent as an HTTP request body. In some embodiments, personalization data can be encoded in a data exchange format, such as XML or JSON data. In some embodiments, a server can respond to a request with an indication that certain personalization data fields are accepted. In response, the browser can send a separate request containing personalization data.

### Example Use Cases

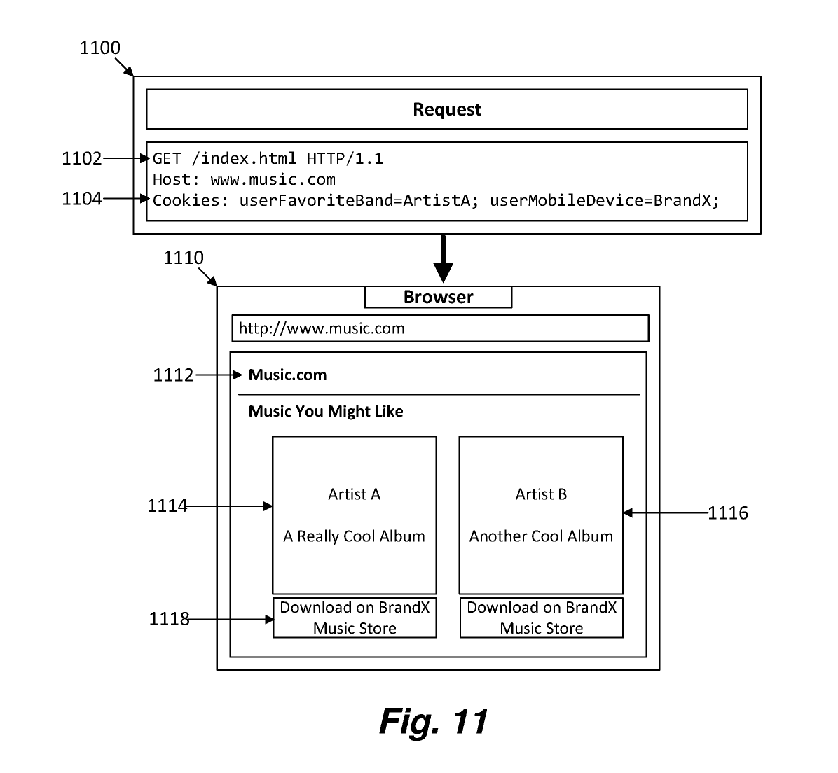

The following exemplary use cases describe examples of possible implementations of the disclosed technology. They are intended solely for explanatory purposes and not in limitation. FIG. 11 illustrates an example of visiting a music store in accordance with an embodiment. Using a browser implementing methods in accordance with a disclosed technology, a user may choose to visit a music store, such as music.com. Because the browser informs the web server that the user's favorite band is Artist A, and that they own mobile phone from Brand X, the web site 1112 presented to the user is customized to display albums from their favorite band 1114, as well as related bands (e.g. same genre, solo albums of band members, etc.), and displays download links appropriate to the brand of mobile phone owned by the user 1118.

The presentation of the personalized website is facilitated according to embodiments of the disclosed technology. Here, the user has previously indicated to the browser that their favorite band is Artist A, and that they have a mobile device from Brand X. When the user types “www.music.com^{”} into their browser, their browser sends a request 1100 for the main page 1102 (index). The request contains a header field 1104 that contains a cookie for the user's favorite band and the user's mobile device brand. The value of these cookies were not previously provided to the browser by a server using a “Set-Cookie” header. In response, the server responds with a webpage for Music.com 1112 displayed by browser 1110. Because the server knew the user's favorite band, the webpage 1112 is customized to show an album from the user's favorite band 1114 for purchase. Further, the webpage can further display other related artists, such as Artist B, that the user might also like based on their favorite band. Additionally, because the server knows the brand of the user's mobile device, it can provide a download button 1118 to download the album from Artist A on the music store corresponding to that mobile device brand. In addition to providing relevant information to a user, this allows the webpage to minimize visual clutter by not displaying buttons linking to downloads on other music stores.

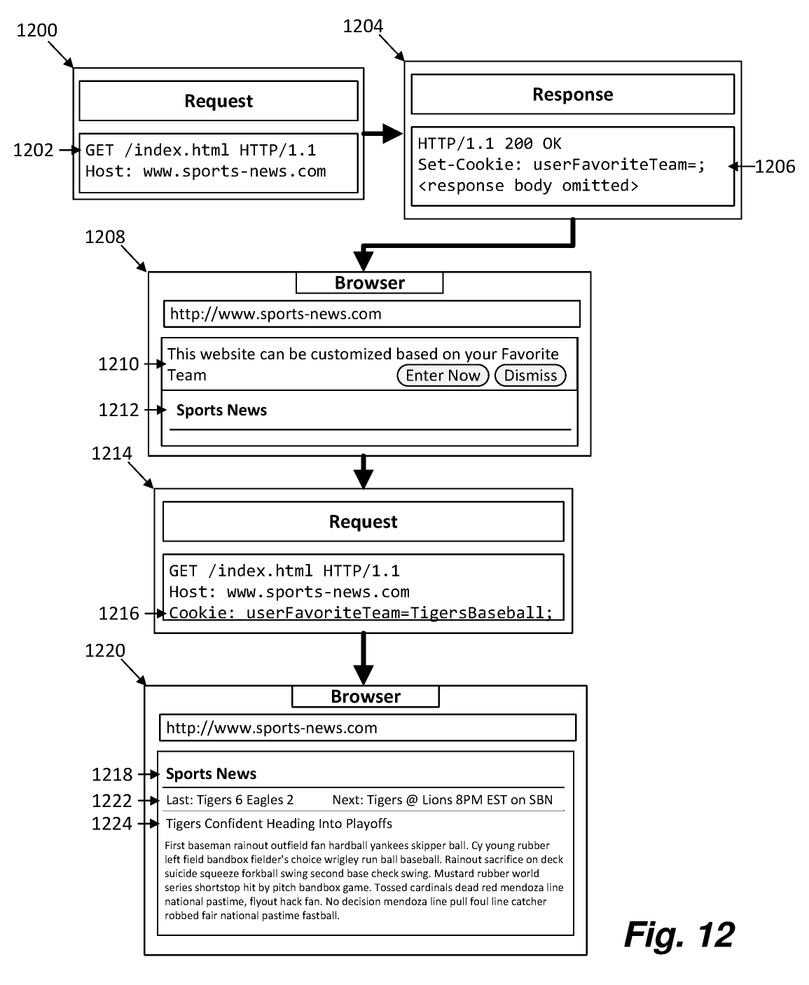

FIG. 12 illustrates another example of visiting a news site in accordance with an embodiment. Here, a user visits a sports news website 1212 and receives an un-personalized version of the web page, because the user has not previously provided an indication of their favorite sports teams. The browser displays a graphical user interface 1210 to ask the user if they would like to provide their favorite sports team. If the user decides to enter their favorite sports team, the website 1218 is then customized to their favorite sports team, such as, for example, displaying recent scores 1222 or news stories about their team 1224.

The presentation of the personalized sports news website is facilitated according to embodiments of the disclosed technology. In this example, a user sends a request 1200 for the main page for a sports news website 1202 without any personalization data. The web server sends back a response 1204 that includes a Set-Cookie header 1206 for “userFavoriteTeam” without a value. The browser 1208 displays a generic and non-personalized version of the web page 1212. Further, the browser interprets the Set-Cookie header as a request for personalization data from the user, and displays a dialog box 1210 to the user. The user then enters the personalization data in a text box, for example. If the user sends another request for the index page 1214, the browser will include a cookie 1216 indicating that the user's favorite team is the Tigers Baseball team. The server will then return a personalized page 1218 to be displayed by browser 1220 that includes personalized information, such as recent scores and upcoming schedules for the team 1222, and news items of particular interest regarding the user's favorite team 1224.

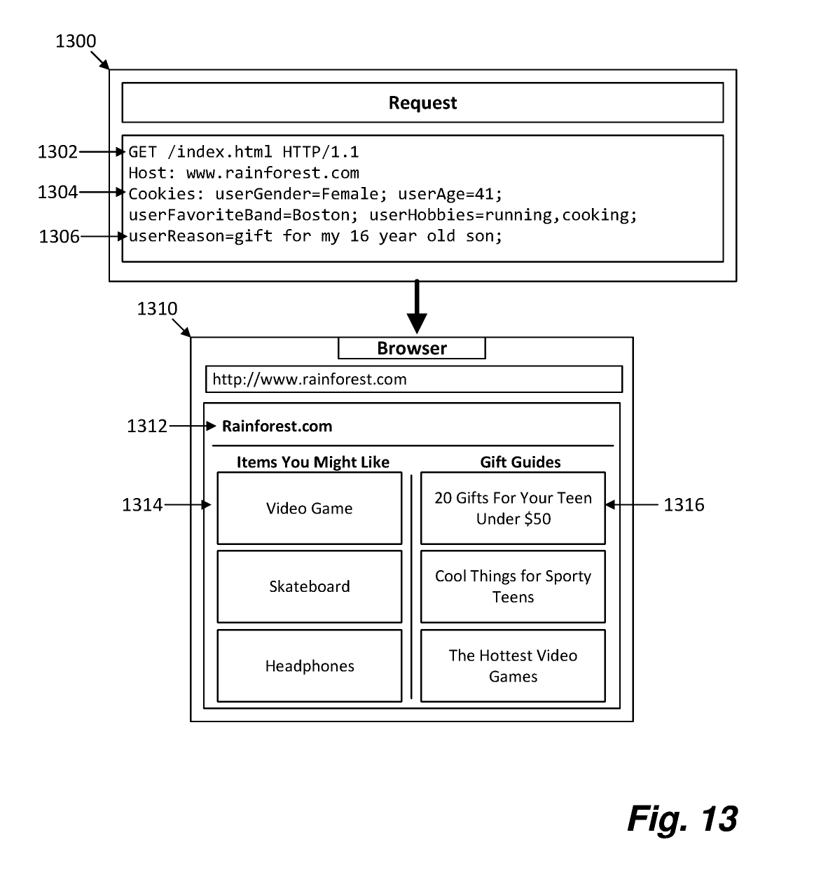

FIG. 13 illustrates another example of visiting a retailer in accordance with an embodiment. Here, a user with a specific profile, such as a 41-year-old female interested in running and cooking 1304, visits a website for a major retailer, such as rainforest.com. The user can indicate a purpose for browsing 1306, such as to shop for a gift for their 16-year-old son. In some embodiments, the browser can send the purpose in a cookie as a natural language phrase, such as “gift for my 16 year old son” 1306. In some embodiments, the browser may process the user's indicated purpose to set one or more cookies representing the indicated purpose. For example, with the indicated purpose of “gift for my 16 year old son,” the browser can process the purpose to set a cookie indicating that the user is looking for a gift (e.g. “userGift=True”) and that the recipient is a 16-year old male (e.g. “userGiftRecipientGender=M; userGiftRecipientAge=16.” In response to either the natural language cookie or the one or more cookies indicating the purpose, the website for the retailer 1312 displays personalized content relevant to the reason for browsing, even if that personalized content would not normally be associated with the user, such as items of interest to 16 year old boys 1314, or gift guides for teenagers 1316.

The presentation of personalized shopping information is facilitated according to embodiments of the disclosed technology. In this example, a user sends a request 1300 to an online retailer, such as rainforest.com 1302. The request contains a number of items of personalization data, indicating that this user is a 41 year old female who enjoys running and cooking. The user has also provided a cookie 1306 indicating that the reason for browsing is to locate a gift for her 16 year old son. In response to the request, the web server realizes that the user is not shopping for herself, and is looking for items for a 16 year old boy. As a result, it returns a personalized web page 1312 to browser 1310 with content that would not be personalized to a 41 year old female interested in running and cooking, but is appropriate to her reason for browsing. This can include item recommendations 1314, such as a video game, skateboard, or headphones, or articles and gift guides 1316 with ideas for possible purchases.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

1-26. (canceled)

27. A method for providing a personalized browsing experience, comprising:
receiving, through a browser, a first request from a user for a web site;
outputting the first request without appending personalization data;
receiving, from the web site, an un-personalized version of a web page and an indication of personalized data accepted by the web page;
outputting, through the browser, the un-personalized web page and an interface asking the user to provide the personalized data accepted by the web page, the interface being displayed within the un-personalized web page and in response to receiving the indication of personalized data accepted by the web page;
receiving, through the interface, the personalized data accepted by the web page;
storing the personalized data accepted by the web page;
receiving a second request from the user for the web site;
appending the personalized data accepted by the web page to the second request for the web site; and
receiving, from the web site, a personalized version of the web page.

28. The method of claim 27, wherein the interface comprises a dialog box.

29. The method of claim 28, wherein the interface further comprises a text box configured to receive personalized data entered by the user.

30. The method of claim 27 further comprising determining that the personalized data can be sent to the web site based on a user setting indicating that the web site is an allowed web site or a disallowed website.

31. The method of claim 27 further comprising determining that the personalized data can be sent to the web site based on a list of allowed or responsive personalized data associated with the web site.

32. The method of claim 27, wherein the personalized data is stored on a user profile of the user.

33. The method of claim 32 further comprising selecting the user profile from among a plurality of profiles associated with the user.

34. The method of claim 27, wherein the personalized data is appended to the second request for the web site as a cookie.

35. The method of claim 27 further comprising determining that the personalized data can be sent to the web site based on a whitelist of allowed web sites.

36. The method of claim 27 further comprising determining that the personalized data can be sent to the web site based on a blacklist of disallowed web sites.

37. A method for providing a personalized browsing experience, comprising:
receiving a request from a user for a web site;
requesting, from a database, an indication of personalization data accepted by the web site;
receiving, from the database, an indication of the personalization data accepted by the web site;
identifying absent personalization data of the indicated personalization data absent from a user profile;
outputting an interface asking the user to provide the absent personalization data;
receiving, through the interface, an indication of the absent personalization data;
updating the user profile to include an indication of the absent personalization data received through the interface; and
appending the indicated personalization data to the request for the web site, the indicated personalization data being selected from the user profile.

38. A method for providing a personalized browsing experience, comprising:
receiving, at a browser, one or more first items of personalization data from a user profile associated with a user;
receiving, at the browser and from the user, one or more second items of personalization data corresponding to a natural language description of a purpose for browsing;
receiving a request from a user for a web site;
appending the one or more first items of personalization data and the one or more second items of personalization data to the request for the web site; and
receiving, from the web site, a personalized web page based on the one or more second items of personalization data,
wherein the natural language description states that the user is shopping for a gift, and the one or more second items of personalization data comprise setting at least one key value pair, the at least one key value pair comprising at least one of an indication of a search for a gift, an indication of a recipient gender, and an indication of a recipient age.

39. The method of claim 28, wherein the at least one key value pair comprises at least one of “userGift=True,” “userGiftRecipientGender=M,” and “userGiftRecipientAge=16.”
